(19) United States
(12) Patent Application Publication
(10) Pub. No.: US 2022/0062674 A1
(43) Pub. Date: Mar. 3, 2022

(54) BREATHING HALF MASK AND PROCESS FOR MANUFACTURING A BREATHING HALF MASK

(71) Applicant: Dräger Safety AG & Co. KGaA, Lübeck (DE)

(72) Inventors: Michael ROSERT, Timmendorfer Strand (DE); Eiko HASEMANN, Großhansdorf (DE); Mathias SCHOLZ, Hamburg (DE); Katrin HINZ, Nahe (DE); Alexander GRÜNKE, Lübeck (DE)

(21) Appl. No.: 17/416,036

(22) PCT Filed: Dec. 20, 2019
(86) PCT No.: PCT/EP2019/086503

§ 371 Date: Jun. 18, 2021

(30) Foreign Application Priority Data
Dec. 21, 2018 (DE) 10 2018 009 982.3

(51) Int. Cl. A62B 23/02; A41D 13/11; A62B 18/08

(52) U.S. Cl. CPC A62B 23/025; A62B 18/084; A41D 13/1115

(57) ABSTRACT

A breathing half mask, which can be brought by a folding operation from a storage state into a use state. A mouth area is arranged between a nose area (11) with a nose sealing line (41) and a chin area (12) with a chin sealing line (42). A first connection section (14.1, 14.2) connects the nose area (11) and/or the chin area (12) to the mouth area. A second connection section (15.1, 15.2) connects the nose area (11) and/or the chin area (12) to another mask area (10) in order to limit the nose sealing line (41) and/or the chin sealing line (42). The second connection section (15.1, 15.2) extends a distance from an edge of the nose area (11) and/or from an edge of the chin area (12) between the first connection section (14.1, 14.2) and the nose sealing line (41) and/or the chin sealing line (42).

### CROSS REFERENCE TO RELATED APPLICATIONS

This application is a United States National Phase Application of International Application PCT/EP2019/086503, filed Dec. 20, 2019, and claims the benefit of priority under 35 U.S.C. § 119 of German Application 10 2018 009 982.3, filed Dec. 21, 2018, the entire contents of which are incorporated herein by reference.

### TECHNICAL FIELD

The present invention pertains to a breathing half mask for protection against particles, aerosols and/or odors, wherein (a) the breathing half mask can be brought by at least one folding operation from a storage state into a use state, (b) the breathing half mask has as mask areas a nose area with a nose sealing line, a chin area with a chin sealing line and a mouth area arranged between the nose area and the chin area for defining a breathing space in the use state of the breathing half mask, and (c) the breathing half mask has at least one connection section, which connects the nose area and/or the chin area to the mouth area to form at least one partial folded area for the at least one folding operation. The present invention pertains, furthermore, to a process for manufacturing a breathing half mask mentioned in the introduction.

### TECHNICAL BACKGROUND

Breathing half masks, especially particle-filtering breathing half masks, are known, in principle. Breathing half masks protect the persons wearing them, depending on the embodiment, from the inhalation of aqueous or oily aerosols and/or particles, for example, fine dust or the like. They do not usually offer any protection against gases and vapors. Prior-art breathing half masks often consist predominantly of a filter material, for example, a nonwoven, and have, furthermore, rubber bands and a pliable nose clip in order to make possible an especially good adaptation to the face of a user. Prior-art designations for breathing half masks also comprise fine dust masks, dust masks or the English term Filtering Face Pieces.

Such breathing half masks often have, in addition to the protective filter material, layers of an electrostatic material. Fine dust particles and liquid drops are thus bound by electrostatic forces. The electrostatic effect decreases over the time of use due to the deposit of dust, so that there will be a marked increase in the breathing resistance. Such breathing half masks are usually intended only for a single-time use, for example, in the course of a workday lasting 8 hours.

The prior-art breathing half masks can be classified mainly to preformed and folded breathing half masks. The folded breathing half masks may be further classified into vertically folded breathing half masks, horizontally folded breathing half masks and beak masks.

Breathing half masks may be manufactured and supplied in different sizes. To ensure correct seating of the breathing half mask on the face of the user, the user must select a breathing half mask of a size that corresponds to the size of the head and/or of the face.

GB 871661 shows a breathing half mask (disposable face mask 10), which can be folded up flatly and can be unfolded for use. A central area (central part 17) is arranged in front of the mouth between two marginal areas (marginal parts 13a, 13b) at the level of the nose or of the chin of a user. Two connection sections (regions 11, 12) connect the marginal areas 13a, 13b to the central area and form folding areas for the folding operation.

US 2010/0051032 A1 shows a foldable breathing half mask (four-sided dust-proof mask), which has a nose area with a nose sealing line (upper filter 11), a chin area with a chin sealing line (lower filter 12) and a mouth area (center filter 10) between the nose area 11 and the chin area 12. Two connection sections 11 (upper folding line 21, lower folding line 21) connect the nose area 11 and the chin area 12 to the mouth area 10.

The foldable breathing half mask according to EP 0032422 A1 likewise comprises a nose area with a nose sealing line (area 12 with upper edge 14 and upper binder strip 26), a chin area with a chin sealing line (area 20 with lower edge 16 at the bottom and with lower binder strip 26) and a mouth area between the nose area 12 and the chin area 30 (area between the lines 22). The breathing half mask is limited laterally by two elements (rows of stitching 28).

### SUMMARY

A basic object of the present invention is to propose a breathing half mask for protection against particles, aerosols and/or odors as well as a process for manufacturing such a breathing half mask, wherein the breathing half mask, while providing sufficiently good wear comfort, can be manufactured in a relatively simple manner.

Features and details that are described in connection with the breathing half mask also apply, of course, in connection with the process according to the present invention and vice versa, so that reference is and can always mutually be made to the individual aspects of the present invention concerning the disclosure.

According to a first aspect of the present invention, one object is accomplished by a breathing half mask for protection against particles, aerosols and/or odors, wherein (a) the breathing half mask can be brought by at least one folding operation from a storage state into a use state, (b) the breathing half mask has as mask areas a nose area with a nose sealing line, a chin area with a chin sealing line and a mouth area arranged between the nose area and the chin area for defining a breathing space in the use state of the breathing half mask, and (c) the breathing half mask has at least one first connection section, which connects the nose area and/or the chin area to the mouth area to form at least one partial folding area for the folding operation or for a folding operation. The breathing half mask according to the present invention has (d) at least one second connection section, which connects the nose area and/or the chin area to at least one of the other mask areas to limit a length of the nose sealing line and/or a length of the chin sealing line. The connection section or a second connection section extends (e) at least partially to an area of the nose area and/or to an area of the chin area located at a spaced location from an edge of the nose area and/or from an edge of the chin area between the first connection section or a first connection section and the nose sealing line and/or the chin sealing line.

“The first connection section” and “the second connection section” as well as an optional third connection section will be referred to in the following description. If the breathing half mask has a plurality of first and/or a plurality of second and/or a plurality of third connection sections, the following description pertains to at least one first and to at least one second and to at least one third connection section. The description may also refer simultaneously to a plurality of first, a plurality of second and/or a plurality of third connection sections.

A breathing half mask according to the present invention is in many cases capable of protecting a user from particles and aerosols. The breathing half mask may be brought to this end into a use state in which it is configured to cover the nose and the mouth of a user. The breathing half mask fits by itself the head of a user and/or is fixed by itself alone by means of optional additional elements, for example, a holding band, especially a rubber band, and/or a nose clip, which parts may be arranged at the breathing half mask. In addition to the use state already described, the breathing half mask may also be in a storage state, in which the breathing half mask can be folded up and can as a result be stored in a space-saving manner. The breathing half mask can preferably be deformed reversibly between the storage state and the use state by at least one folding operation, especially by a horizontal folding operation.

The breathing half mask according to the present invention has a plurality of, namely, at least three mask areas, namely, a nose area, a chin area and a mouth area arranged between the nose area and the chin area. The nose area and the chin area of the breathing half mask according to the present invention have a nose sealing line and a chin sealing line, especially in order to make it possible to provide a sealing when being placed on the corresponding parts of the face of a user. These sealing lines may also additionally be improved, for example, concerning their sealing effect by a corresponding coating. A mouth area, which defines a breathing area of the breathing half mask in the use state of the breathing half mask, is arranged between the nose area and the chin area. This breathing space is arranged between the mouth and the nose of the user and the mouth area of the breathing half mask according to the present invention. The individual mask areas of a breathing half mask according to the present invention thus form the structure of a breathing half mask according to the present invention. Further optional elements, for example, the holding band, the nose clip and/or fastening elements for fastening, for example, the holding band and/or the nose clip at the breathing half mask, may complement the breathing half mask according to the present invention.

The first connection section connects especially an edge of the nose area and/or to an edge of the chin area to an edge of the mouth area. The first connection section can provide or form the folding area or the larger part of the folding area for the folding operation. The folding area is, at any rate, reduced by the second connection section in a breathing half mask according to the present invention compared to a folding area of a breathing half mask not according to the present invention without the second connection section. The length of the nose sealing line and/or the length of the chin sealing line are shortened here in a breathing half mask according to the present invention compared to the length of the nose sealing line and/or the length of the chin sealing line of a breathing half mask not according to the present invention without the second connection section. It could also be said that the second connection sections divide the nose sealing line and the chin sealing line into an unusable nose sealing line and an unusable chin sealing line and into a usable nose sealing line and a usable chin sealing line. Unlike the unusable nose sealing line and the unusable chin sealing line, the usable nose sealing line and the usable chin sealing line can be used in the use state of the breathing half mask for defining the breathing space and be placed sealingly on the parts of the face of the user of the breathing half mask or they come into contact by themselves. It is also possible that in the use state of the breathing half mask the two second connection sections shorten the nose sealing line and the chin sealing line to the usable nose sealing line and to the usable chin sealing line, compared to the storage state of the breathing half mask, and an unusable nose sealing line and an unusable chin sealing line are formed.

Provisions are frequently made in prior-art folded breathing half masks for these to be able to be converted between a storage state and a use state by a folding operation. This folding operation may be difficult and laborious for a user of a prior-art breathing half mask, for example, if the individual mask areas move again away from their positions in the use state, especially when the breathing half mask is too large or too small, as a result of which it is applied incorrectly and leaks of the breathing half mask may thus develop. At least one part of a breathing half mask that is too small may also come very close to the mouth of the user, as a result of which the user may come to feel that he is in a crowded space during the use of the breathing half mask. This crowded breathing space may also lead in prior-art breathing half masks to a region with increased humidity, as a result of which the breathing resistance of the breathing half mask is increased and an elevated temperature is additionally produced under the breathing half mask due to the tight contact of the breathing half mask.

Unit sizes of breathing half masks are currently usually offered commercially. When fixing a breathing half mask of a unit size on especially small and/or large head sizes and shapes, poorly sealing seating and poor wear comfort are often experienced. A breathing half mask of a unit size can, moreover, be very difficult to put on and the chin area of the breathing half mask slips partially disadvantageously from the chin to the mouth in case of large heads. By contrast, the breathing half mask slips in case of small heads in case of a unit size very far upward on the face, so that the breathing half mask will disadvantageously also touch the region of the eyes. A breathing half mask of a unit size is, moreover, very close to the mouth in case of small heads, which leads to the feeling of having a crowded breathing space.

By contrast, thanks to the connection section or to at least one second connection section, the breathing half mask according to the present invention can be manufactured in a simple and cost-effective manner in different sizes because mask areas of the same size can be manufactured and provided for different sizes of the breathing half mask. The hitherto necessary manufacturing step in which mask areas of different sizes must be manufactured and provided for manufacturing breathing half masks of a different size is thus eliminated because, due to the second connection section, the nose sealing line and/or the chin sealing line of the breathing half mask according to the present invention are made shorter compared to the nose sealing lines and/or chin sealing lines of equal size, which are provided with the mask areas of equal size, in a simple and cost-effective manner. The breathing half mask, especially the breathing space, is made smaller in case of a shorter nose sealing line and/or shorter chin sealing line. The desired size of the breathing half mask can be set individually during the manufacture by selecting the location or the area at which location or area the second connection section is arranged at the nose area and/or at the chin area. For example, the mask areas may be manufactured solely in one predefined size XL and reduced to a predefined size L, M or S by the second connection section depending on the location or the area of the nose area and/or of the chin area at or in which the second connection section is formed.

Moreover, it is possible to change the size of an already manufactured breathing half mask, because the arrangement of the second connection section can be carried out only after the individual mask areas have been connected to the breathing half mask. This makes it possible to carry out the additional manufacturing step in which the size of the breathing half mask is reduced at the end of the manufacturing process, so that manufacturing processes used hitherto do not have to be changed or they have to be changed only slightly. The implementation of this manufacturing step can thus be carried out in the current manufacturing process in an especially simple and cost-effective manner.

The breathing half mask preferably has at least two and especially precisely two first connection sections, which connect each at least the nose area and the chin area to the mouth area to form a partial folding area for the folding operation or for at least one folding operation.

Furthermore, the breathing half mask preferably has at least two and especially two or at least four or precisely four second connections sections, which connect the nose area and/or the chin area to at least one of the other mask areas to limit a length of the nose sealing line and/or a length of the chin sealing line.

In a preferred embodiment of the breathing half mask according to the present invention, the second connection section extends at least partially over an area of the nose area and/or over an area of the chin area at a distance from an edge of the nose area and/or from an edge of the chin area between the first connection section and the nose sealing line and/or the chin sealing line. The edge of the nose area and/or the edge of the chin area preferably have here the connection section. The length of the nose sealing line and/or the length of the chin sealing line can be limited in a simple manner and with a high level of freedom of design due to such an arrangement of the second connection section at the nose area and/or at the chin area.

In another preferred embodiment of the breathing half mask according to the present invention, the second connection section connects the nose sealing line and/or the chin sealing line to the mouth area to limit the length of the nose sealing line and/or the length of the chin sealing line. The connection of the nose sealing line and/or of the chin sealing line at the mouth area is especially stable because the nose sealing line and/or the chin sealing line are thus limited at the location at which the strongest pulling forces act as a consequence of the folding up during the folding up of the breathing half mask from the storage state into the use state. The second connection section will not accordingly break or tear in many cases even when a user puts on a breathing half mask according to the present invention of a size that is too small for his head or his face.

In yet another preferred embodiment of the breathing half mask according to the present invention, the second connection section connects the nose sealing line to the chin sealing line to limit the length of the nose sealing line and the length of the chin sealing line. The limited length of the nose sealing line advantageously corresponds here to the limited length of the chin sealing line, so that the breathing half mask is reduced uniformly in size and fits perfectly both on a left part of the face and on a right part of the face of the user.

In another preferred embodiment of the breathing half mask according to the present invention, the second connection section connects the nose area, the chin area and the mouth area to one another. Due to the arrangement of the connection in all mask areas, an especially stable connection is achieved, because the pulling forces acting on the second connection section during the folding up of the breathing half mask from the storage state into the use state are distributed among all areas of the mask.

In an advantageous embodiment of the breathing half mask according to the present invention, the second connection section has a configuration that is at right angles or essentially at right angles to a horizontal extension of the breathing half mask in the use state, i.e., on the face of a user. At right angles means here an angle of 90°. Essentially at right angles means especially an angle of 70° to 110°. The horizontal extension is especially the longest extension of the breathing half mask in the storage state, i.e., in the folded-up state. The horizontal extension extends in the use state in the transverse plane of the user, who is using the breathing half mask. The horizontal extension of the breathing half mask thus extends along a line at right angles to the longitudinal axis of the stretched-out user. In case of a standing person, the horizontal extension extends along a line horizontal in relation to the floor. As a result, an especially stable limitation of the nose sealing line and/or chin sealing line can be achieved against forces occurring during folding up of the breathing half mask, so that the connection section can be made smaller. This saves material costs and manufacturing time.

In another advantageous embodiment of the breathing half mask according to the present invention, the second connection section comprises, due at least to a connection in substance, especially a weld seam or bonding, at least one welded-in plastic part and/or at least one mechanical clamp. A weld seam can be prepared in a cost-effective manner and is nevertheless very stable. A bonding may be preferable in case of some filter materials of the mask area compared to another connection. A welded-in plastic part is especially stable, because the plastic part represents an additional structural part, which connects the filter materials of the mask areas to one another and holds them together. A mechanical clamp can be fastened without additional tools, for example, welding devices and plastic applicators, and it can therefore also be attached to the mask areas manually. It may have for this purpose, for example, at least two meshing sections, for example, in the form of hooks, which mesh with the filter material. The first connection section and additional connection sections may also comprise at least a connection in substance, especially a weld seam or bonding, at least a welded-in plastic part and/or at least a mechanical clamp, especially in one of the above-described variants.

In an advantageous embodiment of the breathing half mask according to the present invention, the second connection section is arranged at a distance of 1% to 30%, preferably 3% to 25%, especially preferably 5% to 15% of the length of the breathing half mask from the first length end or from the second length end, which length is measured from one length end of the breathing half mask to a second length end of the breathing half mask, which second length end is located opposite the first length end, in the direction of the transverse extension of the breathing half mask in the use state. It can be avoided hereby that excessively strong forces, which could damage the filter material of the mask areas, would occur during the folding up at the longitudinal ends, at which fastening elements for holding bands are typically arranged as well. In addition, it was found that a sufficiently great, but not too great a shortening of the sealing lines is possible hereby in order to provide the breathing half mask according to the present invention in the sizes necessary for users and to use for this, insofar as possible, the same mold for breathing half masks of different sizes.

In another embodiment of the breathing half mask according to the present invention, at least a third connection section is arranged next to the second connection section such that the third connection section additionally limits the length of the nose sealing line and/or the length of the chin sealing line. In particular, the third connection section is arranged at a spaced location from the second connection section. The third connection section may be configured especially in a variant and with features as this is described or shown in the description and in the drawings for the second connection section. The second connection section and the third connection section may especially have different configurations. For example, the second connection section may be configured as a plastic part welded into the filter material and the third connection section as a weld seam. It may, for example, be advantageous in some forms of the breathing half mask to set the geometry of the breathing space or a maximum size of the breathing half mask by means of the second connection section and to limit the length of the nose sealing line and/or the length of the chin sealing line, i.e., to reduce the size of the breathing half mask, only by the configuration of the third connection section.

The second connection section and/or the third connection section preferably have an elongated shape. The elongated shape means especially that a longitudinal extension of the connection section is 2 to 30 times and especially 5 to 20 times of a width extension of the connection section. As an alternative or in addition, the second and/or third connection sections may have a rectangular shape, a rectangular shape with rounded corners or an oval shape. This improves the absorption of the pulling forces developing during the definition of the breathing space by the respective connection section. The second connection section and/or the third connection section may, moreover, also be connected to the first connection section.

Due to the limitation by means of the second connection section, the nose sealing line and/or the chin sealing line are preferably shorter in the breathing half mask according to the present invention by 5% to 40%, preferably by 7% to 35%, especially preferably by 10% to 30% and also preferably by 12% to 25% in the use state than in the storage state. Usual sizes of breathing half masks can be provided hereby, and, insofar as possible, breathing half masks can be manufactured in different sizes with the same equipment.

In particular, the breathing half mask according to the present invention is a horizontally folded breathing half mask. This means that the folds between the mask areas extend parallel to the horizontal extension of the breathing half mask as well as at right angles to the longitudinal axis of a person. The mask areas must correspondingly be unfolded in the vertical direction in order to bring the breathing half mask from the storage state into the use state.

The mouth area of a breathing half mask according to the present invention may have a nose reinforcement and/or a chin reinforcement, which reinforce the breathing half mask in the nose area and in the chin area. The nose reinforcement may be arranged at least in some sections overlapping with the nose area and/or the chin reinforcement may be arranged in at least some sections overlapping with the chin area. In particular, either a nose reinforcement or a chin reinforcement, and preferably even both a nose reinforcement and a chin reinforcement may be provided in a breathing half mask according to the present invention. The nose reinforcement is configured, in particular, as a part of the mouth area such that it is arranged at least in some sections overlapping with the nose area. Analogously, the chin reinforcement is configured as a part of the mouth area such that it is arranged at least in some sections overlapping with the chin area. Due to these overlapping areas of the mouth area with the nose area and/or with the chin area, it is possible, in particular, to enlarge the defined breathing space as well as to increase the stability of the breathing half mask. The material thickness is increased at least at the overlapping areas, for example, at least at the sections at which the mouth area is connected to the nose area or to the chin area. As an alternative or in addition, the entire nose reinforcement may also be configured such that it overlaps with the nose area or the entire chin reinforcement and the chin area have an overlapping configuration, as a result of which the material thickness is likewise increased in these areas. It can be automatically ensured hereby and especially due to the folding over of the nose reinforcement and/or of the chin reinforcement that an increased stability is achieved in the folded-up state, i.e., in the use state of the breathing half mask, in these areas. Folding up of the breathing half mask according to the present invention from its use position back in the direction of its storage state can be made difficult in this manner and at best prevented. The defined breathing space is likewise improved by the presence of a nose reinforcement arranged overlapping with the nose area and of a chin reinforcement arranged overlapping with the chin area. The folding operation from the storage state into the use state is also supported by this higher stability, especially in terms of the prevention of a folding back from the use state into the storage state.

The folding operation from the storage state into the use state can be facilitated in a breathing half mask according to the present invention by the presence of a nose reinforcement and/or of a chin reinforcement. At the same time, higher stability is provided for the breathing half mask according to the present invention, as a result of which it is also possible, in particular, to provide a large breathing space in front of the mouth or of the nose of a user by the breathing half mask according to the present invention. It was found that the nose reinforcement and/or chin reinforcement of a breathing half mask according to the present invention can be provided in a unit size for different sizes of the breathing half mask, so that, in addition to the mask areas, the nose reinforcement and/or the chin reinforcement do not have to be provided in different sizes, either. Likewise, the nose reinforcement and/or the chin reinforcement may be provided in different sizes depending on the size of the breathing half mask to be manufactured in order to improve the seating of the breathing half mask even further. An overall increased wear comfort can thus be provided by a breathing half mask according to this embodiment.

The second connection section is preferably arranged in the breathing half mask according to the present invention closer to the first longitudinal end in the direction of the horizontal extension of the breathing half mask than at the middle of the breathing half mask. It is ensured hereby that a sufficiently large breathing space is defined by the mouth area, so that the breathing half mask is especially comfortable. Two second connection sections are preferably also located opposite each other at the first longitudinal end and at the second longitudinal end of the breathing half mask. As a result, a load exerted on the second connection sections during the definition of the breathing space is distributed uniformly. This risk that one of the two second connection sections will tear or break is low, so that such a breathing half mask has an especially stable configuration. In addition, an appearance of the breathing half mask used by the user, which is symmetrical in relation to the sagittal plane, can be generated hereby in the use state, because the sealing lines can be arranged symmetrically at the face parts of the user. This is achieved especially by the two second connection sections being arranged each at an essentially equal distance from the first and second longitudinal ends. Essentially means here that deviations by up to 20% between the distances may exist. The appearance is improved further if the same type of connection as the first connection and the second connection is selected.

According to a second aspect of the present invention, an object is accomplished by a process for manufacturing the breathing half mask according to the present invention, which can be brought by at least one folding operation from a storage state into a use state, with the following steps: (a) Provision of the nose area, of the chin area and of the mouth area, and (b) connection of the nose area and/or of the chin area to the mouth area by means of the first connection section, which connects the nose area and/or the chin area to the mouth area to form a partial folding area for the folding operation, (c) connection of the nose area and/or of the chin area to at least one of the other mask areas by means of the second connection section such that the length of the nose sealing line and/or the length of the chin sealing line is limited.

Further measures improving the present invention appear from the following description of some exemplary embodiments of the present invention, which are shown in the figures. All the features and/or advantages appearing from the claims, from the description or from the drawings, including structural details and arrangements in space, may be essential for the present invention both in themselves and in the different combinations. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an oblique view of an exemplary embodiment of a breathing half mask according to the present invention applied by a user in the use state;

FIG. 2 is a top view of mask areas at a process step of an exemplary embodiment of the process according to the present invention for manufacturing a breathing half mask;

FIG. 3a is a top view of a first exemplary embodiment of a breathing half mask according to the present invention in the storage state;

FIG. 3b is a detail view of the first exemplary embodiment of a breathing half mask according to the present invention from FIG. 3a;

FIG. 4a is a top view of a second exemplary embodiment of a breathing half mask according to the present invention in the storage state;

FIG. 4b is a detail view of the second exemplary embodiment of the breathing half mask according to the present invention from FIG. 4a; and

FIG. 5 is a top view of the second exemplary embodiment of a breathing half mask according to the present invention from FIG. 4a in the use state.

### DESCRIPTION OF PREFERRED EMBODIMENTS

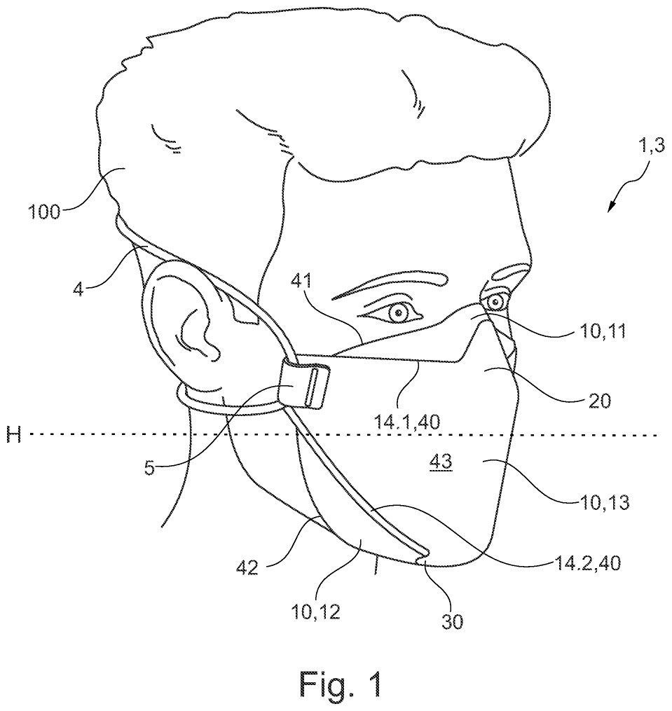

Referring to the drawings, elements having the same function and mode of operation are always designated by the same reference numbers in FIGS. 1 through 5.

FIG. 1 shows a breathing half mask 1 according to the present invention in its use state 3 during use by a user 100. The breathing half mask 1 shown is a horizontally foldable breathing half mask 1. The breathing half mask 1 according to the present invention has in this exemplary embodiment three mask areas 10. The three mask areas 10 are a nose area 11, a chin area 12 as well as a mouth area 13. The nose area 11, the chin area 12 and the mouth area 13 extend along a horizontal extension of the breathing half mask 1, which follows a broken line. The nose area 11, the chin area 12 and the mouth area 13 are arranged in a vertical direction relative to one another. The mask areas 10 may have especially textile filter materials or may consist of textile filter materials, for example, nonwovens. Mechanical and/or electrostatic and/or triboelectric filter materials may be used, especially for the mouth area 13, to provide a filter property. The entire breathing half mask 1 can be attached to the head of a user 100 by means of a holding band 4, which is arranged at the mouth area 13 of the breathing half mask 1 according to the present invention. The nose and the mouth of the user 100 can be securely covered in this manner by a breathing half mask 1 according to the present invention, and a breathing space 43 can be defined in front of the mouth and the nose of the user 100 especially by the mouth area 13. The nose area 11 has a nose sealing line 41 for better sealing against the user 100, and the chin area 12 has a corresponding chin sealing line 42. First connection sections 14.1, 14.2, which also form over a part of their length at the same time a folding area 40 for a folding operation from a storage state 2 (not shown) into the shown use state 3 of the breathing half mask 1 according to the present invention, make it possible to connect the individual mask areas 10. The mask areas 10 are preferably welded to one another at these first connection sections 14.1, 14.2.

A nose reinforcement 20 and a chin reinforcement 30 are provided in this exemplary embodiment at the mouth area 13, which is preferred but not necessary for the embodiment of the present invention. The nose reinforcement 20 and the chin reinforcement 30 are preferably formed in one piece with the rest of the mouth area 13. Both the nose reinforcement 20 and the chin reinforcement 30 are arranged in this embodiment shown on a surface of the nose area 11 and of the chin area 12 facing away from the breathing space 43. The nose reinforcement 20 and the chin reinforcement 30 extend each overlapping with the nose area 11 and with the chin area 12 and preferably have a higher stiffness than the respective covered nose area 11 or chin area 12. The nose reinforcement 20 may also be connected permanently, for example, especially welded, to the nose area 11 and the chin reinforcement may be connected to the chin area 12. Due to the presence of the nose reinforcement 20 and of the chin reinforcement 30, a higher stiffness can be provided for the entire breathing half mask 1 according to the present invention. This increased stiffness may also be provided already by the simple presence of either the nose reinforcement 20 or alternatively of the chin reinforcement 30. The folding operation from the storage state 2 into the use state 3 of a breathing half mask 1 according to the present invention may also be supported by the nose reinforcement 20 and by the chin reinforcement 30. Folding up of the breathing half mask 1 from its use state 3 back into the storage state 2 can be prevented or at least made rather difficult by the presence of the nose reinforcement 20 and of the chin reinforcement 30. Further, the defined breathing space 43 can be increased in an especially simple manner by the nose reinforcement 20 and by the chin reinforcement 30, as a result of which the wear comfort for the user 100 can be increased, on the whole, with the use of a breathing half mask 1 according to the present invention.

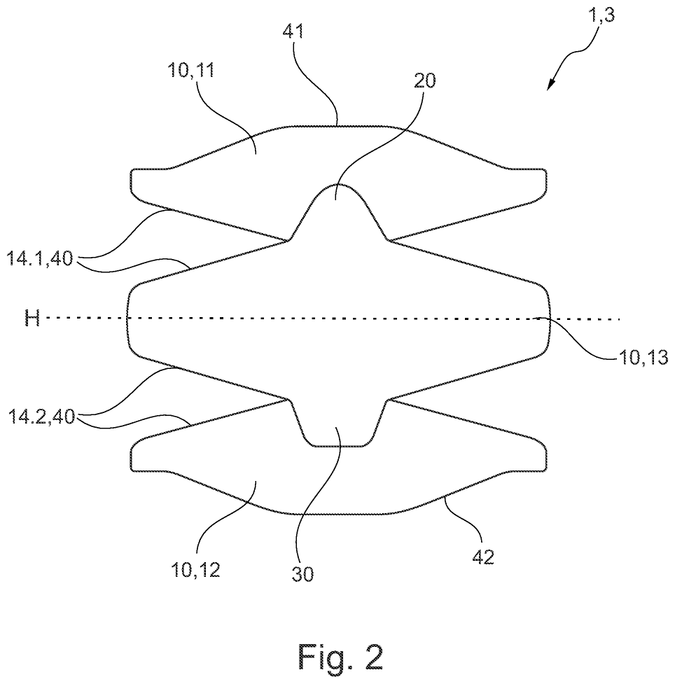

FIG. 2 shows mask areas at a process step of an exemplary embodiment of the process according to the present invention for manufacturing a breathing half mask 1. The individual mask areas 10, especially the nose area 11, the mouth area 13 as well as the chin area 12 are already arranged vertically. Respective adjacent mask areas 10 are connected to one another at least partially by welding at their respective first connection sections 14.1, 14.2. It is clearly visible here that the nose reinforcement 20 and the chin reinforcement 30, which have at least essentially a triangular or trapezoid shape in this embodiment, extend overlapping over the nose area 11 and the chin area 12, respectively. At the same time, the nose reinforcement 20 and the chin reinforcement 30 are not necessary for the present invention, especially not for connecting the mask areas 10 to one another. The remaining sections of the first connection sections 14.1, 14.2 can also be connected to one another, especially welded together, by a slight folding up, made possible especially by one embodiment. This slight folding up is made possible, for example, by at least a part of the connection sections 14.1, 14.2 being configured each as a folding area 40. It is also clearly visible in this view that the individual mask areas 10 are preferably configured as one-piece mask sections. An especially simple manufacturing step in the process for manufacturing a breathing half mask 1 according to the present invention can be made possible in this manner.

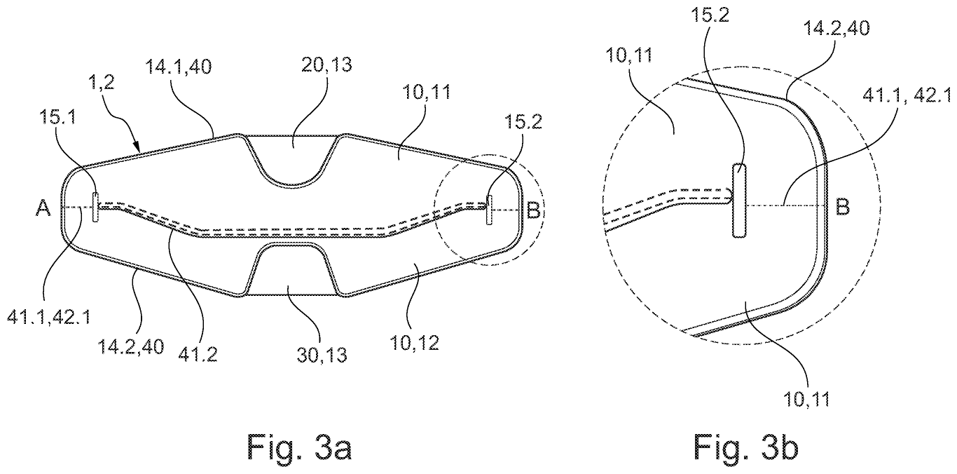

FIG. 3a shows a first exemplary embodiment of a breathing half mask 1 according to the present invention in the storage state 2. The nose area 11 and the chin area 12 were folded vertically in the direction of the mouth area 13 in the breathing half mask 1 shown, so that the nose area 11 and the chin area 12 cover the mouth area 13. The nose area 11 partially covers here the chin area 12 in an area around the nose sealing line 41.2. In other words, the nose area 11 is folded over the chin area 12. A reversed folding of the chin area 12 over the nose area 11 is also possible in the storage state 2.

The length of the nose sealing line 41 as well as the length of the chin sealing line 42 are limited by two second connection sections 15.1, 15.2. The two second connection sections 15.1, 15.2 extend each over an area of the nose area 11 and over an area of the chin area 12 at a distance from an edge of the nose area 11 and from an edge of the chin area 12, especially from the first longitudinal end A and from the second longitudinal end B of the breathing half mask 1, between the two first connection sections 14.1, 14.2 and the nose sealing line 41 as well as the chin sealing line 42. The two first connection sections 15.1, 15.2 connect the nose sealing line 41.1 and the chin sealing line 41.2 to one another. The two second connection sections 15.1, 15.2 have a transverse configuration in relation to the horizontal extension H of the breathing half mask 1.

The two second connection sections 15.1, 15.2 divide the nose sealing line 41 and the chin sealing line 42 especially into an unusable nose sealing line 41.1 and an unusable chin sealing line 42.1, which are indicated by broken lines here, and into a usable nose sealing line 41.2 and a usable chin sealing line 42.2. The unusable nose sealing line 41.1 and the unusable chin sealing line 42.1 are limited each in the direction of one of the longitudinal ends A, B by the two first connection sections 14.1, 14.2 and in the direction of the center of the breathing half mask 1 by the two second connection sections 15.1, 15.2. The usable nose sealing line 41.2 and the usable chin sealing line 42.2 are limited by the second connections sections 15.1, 15.2. Unlike the unusable nose sealing line 41.1 and the unusable chin sealing line 42.1, the usable nose sealing line 41.2 and the usable chin sealing line 42.2 can be used in the use state 2 of the breathing half mask 1 for defining the breathing space 43 and are placed sealingly on the parts of the face of the user 100. The two second connection sections 15.1, 15.2 preferably shorten the nose sealing line 41 and the chin sealing line 42 to the usable nose sealing line 41.2 and to the usable chin sealing line 42.2 in the use state 2 of the breathing half mask 1 by the unusable nose sealing line 41.1 and by the unusable chin sealing line 42.1 in the storage state 3 of the breathing half mask 1.

FIG. 3b shows in an enlarged view a detail of the breathing half mask 1 from

FIG. 3a. The area of the second longitudinal end B of the breathing half mask 1 can be seen. The unusable chin sealing lines 41.1, 42.1 can additionally be connected by an additional connection section, for example, a welding, to one another and especially also to the mouth area 13 both on the second longitudinal end B and on the first longitudinal end A of the breathing half mask.

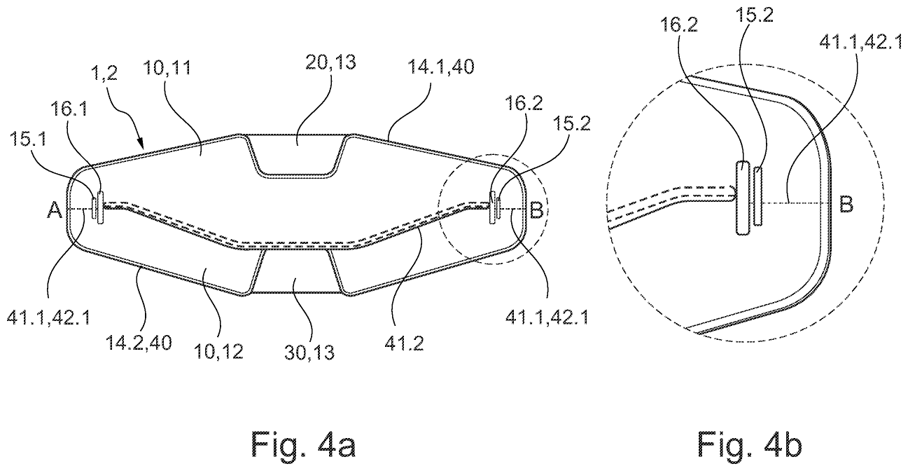

FIG. 4a and FIG. 4b show a second exemplary embodiment of a breathing half mask 1 according to the present invention in the storage state 2. Unlike in the first exemplary embodiment from FIG. 3a and FIG. 3b, the breathing half mask 1 according to the second exemplary embodiment has two third connection sections 16.1, 16.2. The two third connection sections 16.1, 16.2 are arranged each next to the respective connection section of the two second connection sections 15.1, 15.2 such that the two third connection sections 16.1, 16.2 further limit the length of the nose sealing line 41 and the length of the chin sealing line 42. The lengths of the unusable nose sealing line 41.1 and of the unusable chin sealing line 41.2 are increased and the lengths of the usable nose sealing line 41.2 and of the usable chin sealing line 42.2 are shortened. The extension of the two third connection sections 16.1, 16.2 in the vertical direction and in the direction of the horizontal extension H is greater here than that of the two second connection sections 15.1, 15.2. One each of the two third connection sections 16.1, 16.2 is arranged in the direction from the center of the breathing half mask 1 towards the longitudinal ends A, B of the breathing half mask 1 in front of one of the two second connection sections 15.1, 15.2 and at a distance from the respective second connection section 15.1, 15.2. The third connection sections 16.1, 16.2 in the present exemplary embodiment are weld seams, while the second connection sections 15.1, 15.2 are welded-in plastic parts.

The second exemplary embodiment according to FIG. 4a and FIG. 4b shows especially a shape of a breathing half mask 1, in which the geometry of the breathing space 43 is set by means of the second connection sections 15.1, 15.2. Only the two third connection sections 16.1, 16.2 are intended to limit the length of the nose sealing line 41 and the length of the chin sealing line 42 and thus they reduce the size of the breathing half mask 1 from, for example, a size XL without the third connection sections 16.1,16.2 to a size M with the third connection sections 16.1, 16.2.

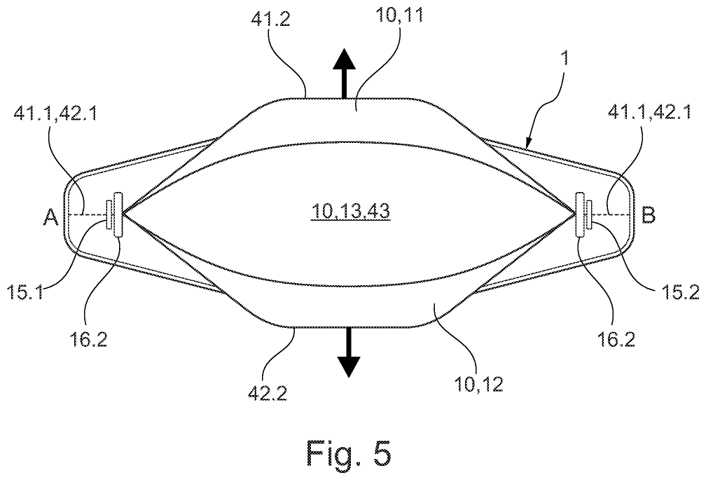

FIG. 5 shows the breathing half mask 1 from FIG. 4a and from FIG. 4b in a view in which the breathing half mask 1 is brought from the storage state 2 into the use state 3. The two arrows at the usable nose sealing line 41.2 and at the usable chin sealing line 42.2 show how the breathing half mask 1 is brought into the use state 3 by folding up the nose area 11 and the chin area 12. The breathing space 43 is defined in the mouth area 13. As can be seen, the nose sealing line 41 and the chin sealing line 42 are limited to the usable nose sealing line 41.2 and to the usable chin sealing line 42.2 by the third connection sections 16.1, 16.2. Only the usable nose sealing line 41.2 and the usable chin sealing line 42.2 can be folded up in order to define the breathing space 43 and to bring it into contact with the parts of the face of the user 100. By folding up the breathing half mask 1 even more, the breathing half mask 1 is brought finally into the use state 2 shown in FIG. 1, wherein the longitudinal ends A, B of the breathing half mask 1 move towards one another due to the folding up.

While specific embodiments of the invention have been shown and described in detail to illustrate the application of the principles of the invention, it will be understood that the invention may be embodied otherwise without departing from such principles.

### LIST OF REFERENCE CHARACTERS

1 Breathing half mask

2 Storage state

3 Use state

4 Holding band

5 Fastening element

10 Mask area

11 Nose area

12 Chin area

13 Mouth area

14 First connection section

15 Second connection section

16 Third connection section

20 Nose reinforcement

30 Chin reinforcement

40 Folding area

41 Nose sealing line

41.1 Unusable nose sealing line

41.2 Usable nose sealing line

42 Chin sealing line

42.1 Unusable chin sealing line

42.2 Usable chin sealing line

43 Breathing space

100 User

A First longitudinal end

B Second longitudinal end

H Horizontal extension

1. Breathing half mask for protection against particles, aerosols and/or odors, wherein the breathing half mask can be brought by at least one folding operation from a storage state into a use state, the breathing half mask comprising:
a nose area with a nose sealing line;
a chin area with a chin sealing line;
a mouth area arranged between the nose area and the chin area for defining a breathing space in a use state of the breathing half mask, the nose area, the chin area and the mouth area serving as three mask areas;
a first connection section, which connects the nose area and/or the chin area to the mouth area and forms a folding area for the folding operation; and
a second connection section, which connects the nose area and/or the chin area to at least one of the other mask areas and which limits a length of the nose sealing line and/or a length of the chin sealing line, wherein the second connection section extends at least partially over an area of the nose area and/or over an area of the chin area at a distance from an edge of the nose area and/or from an edge of the chin area between the first connection section and the nose sealing line and/or the chin sealing line.

2. Breathing half mask in accordance with claim 1, wherein the second connection section connects the nose sealing line and/or the chin sealing line to the mouth area such that the length of the nose sealing line and/or the length of the chin sealing line are limited.

3. Breathing half mask in accordance with claim 1, wherein the second connection section connects the nose sealing line to the chin sealing line such that the length of the nose sealing line and the length of the chin sealing line are limited.

4. Breathing half mask in accordance with claim 1, wherein the second connection section connects the nose area, the chin area and the mouth area to one another.

5. Breathing half mask in accordance with claim 1, wherein the second connection line is arranged at most in the use state at right angles or obliquely or essentially at right angles to a horizontal extension of the breathing half mask in the use state.

6. Breathing half mask in accordance with claim 1, wherein the second connection section is configured by at least one connection materially-bonded, comprised at least by a welded-in plastic part and/or at least by a mechanical clamp.

7. Breathing half mask in accordance with claim 1, wherein the second connection section is arranged at a distance of 1% to 30% of a length of the breathing half mask from a first longitudinal end or from the second longitudinal end, wherein the length from a first longitudinal end of the breathing half mask to a second longitudinal end of the breathing half mask, which latter end is located opposite the first longitudinal end, is measured in the direction of a horizontal extension of the breathing half mask in the use state.

8. Breathing half mask in accordance with claim 1, further comprising a third connection section arranged next to the second connection section such that the third connection section further limits the length of the nose sealing line and/or the length of the chin sealing line.

9. Process for manufacturing a breathing half mask for protection against particles, aerosols and/or odors, wherein the breathing half mask can be brought by at least one folding operation from a storage state into a use state, the process comprising the steps of:
providing a nose area with a nose sealing line, a chin area with a chin sealing line and the mouth area arranged between the nose area and the chin area for defining a breathing space, the nose area, the chin area, and the mouth area serving as three mask areas;
connecting the nose area and/or the chin area to the mouth area by means of a first connection section such that the first connection section connects the nose area and/or the chin area to the mouth area and forms a folding area for the folding operation; and
connecting the nose area and/or the chin area to at least one of the other mask areas by means of a second connection section such that a length of the nose sealing line and/or a length of the chin sealing line are limited.

10. A breathing half mask for protection against particles, aerosols and/or odors, wherein the breathing half mask can be brought by at least one folding operation from a storage state into a use state, the breathing half mask comprising:
a nose area with a nose sealing line;
a chin area with a chin sealing line;
a mouth area arranged between the nose area and the chin area for defining a breathing space in a use state of the breathing half mask, the nose area, the chin area and the mouth area serving as three mask areas;
a first connection section, which connects the nose area and/or the chin area to the mouth area and forms a folding area for the folding operation;
a second connection section, which connects the nose area and/or the chin area to at least one of the other mask areas and which limits a length of the nose sealing line and/or a length of the chin sealing line, wherein the second connection section extends at least partially over an area of the nose area and/or over an area of the chin area at a distance from an edge of the nose area and/or from an edge of the chin area between the first connection section and the nose sealing line and/or the chin sealing line, wherein the breathing half mask is formed by the steps of:
providing the nose area, the chin area and the mouth area, arranged between the nose area and the chin area for defining a breathing space;
connecting the nose area and/or the chin area to the mouth area by means of the first connection section such that the first connection section connects the nose area and/or the chin area to the mouth area and forms a folding area for the folding operation; and
connecting the nose area and/or the chin area to at least one of the other mask areas by means of the second connection section such that the length of the nose sealing line and/or the length of the chin sealing line are limited,

11. A breathing mask in accordance with claim 10, wherein the second connection section connects the nose sealing line and/or the chin sealing line to the mouth area such that the length of the nose sealing line and/or the length of the chin sealing line are limited.

12. A breathing mask in accordance with claim 10, wherein the second connection section connects the nose sealing line to the chin sealing line such that the length of the nose sealing line and the length of the chin sealing line are limited.

13. A breathing mask in accordance with claim 10, wherein the second connection section connects the nose area, the chin area and the mouth area to one another.

14. A breathing mask in accordance with claim 10, wherein the second connection line is arranged at most in the use state at right angles or obliquely or essentially at right angles to a horizontal extension of the breathing half mask in the use state.

15. A breathing mask in accordance with claim 10, wherein the second connection section is configured by at least one connection in substance, comprised by a welded-in plastic part and/or at least by a mechanical clamp.

16. A breathing mask in accordance with claim 10, wherein the second connection section is arranged at a distance of 1% to 30% of a length of the breathing half mask from a first longitudinal end or from the second longitudinal end, wherein the length from a first longitudinal end of the breathing half mask to a second longitudinal end of the breathing half mask, which latter end is located opposite the first longitudinal end, is measured in a direction of a horizontal extension of the breathing half mask in the use state.

17. A breathing mask in accordance with claim 10, further comprising a third connection section arranged next to the second connection section such that the third connection section further limits the length of the nose sealing line and/or the length of the chin sealing line.
